(19) United States
(12) Patent Application Publication
(10) Pub. No.: US 2020/0198998 A1
(43) Pub. Date: Jun. 25, 2020

(54) Chemical Oxygen Demand (COD) Removal Powder Mixture

(71) Applicant: Ecolab USA Inc., St. Paul, MN (US)

(72) Inventors: Ning Jin, Shanghai (CN); Fan Yang, Shanghai (CN); Yueming Zhou, Shanghai (CN)

(73) Assignee: Ecolab USA Inc., St. Paul, MN (US)

(21) Appl. No.: 16/619,179

(22) PCT Filed: Jun. 5, 2018
(86) PCT No.: PCT/IB2018/054012

§ 371 Date: Dec. 4, 2019

(30) Foreign Application Priority Data
Jun. 5, 2017 (CN) 201710412965.5

(51) Int. Cl. C02F 1/52; C02F 1/56; C02F 1/28

(52) U.S. Cl. CPC C02F 1/5245; C02F 2103/28; C02F 1/283; C02F 1/56

(57) ABSTRACT

The present invention is directed at COD removal mixture comprising a) at least one inorganic coagulant; b) activated carbon, c) at least one organic coagulant; and d) optionally water wherein the mixture is a powder and a method of clarifying industrial waste water using the COD removal mixture.

### FIELD OF THE INVENTION

This invention is directed towards chemical oxygen demand (COD) removal mixtures which are powders and the use of these COD removal mixtures for preparing COD removal solutions for use in clarifying industrial wastewater, specifically those wastewaters obtained after biological treatment.

### BACKGROUND OF THE INVENTION

Chemical oxygen demand (COD) is an important parameter for wastewater and is highly regulated. Wastewater originating from several industries, such as coking, paper or chemical industry has to meet more and more stringent COD regulations after conventional biological treatment. Several deep treatment methods are available, such as ozonation, Fenton oxidation and membrane technologies. These methods usually involve large capital investment on equipment and high operational costs.

After biological treatment, total COD of the wastewater arises from the following components: suspended solids, soluble macromolecules and small organic molecules. For the most part, suspended solids can be readily removed from the wastewater by aluminium or iron based coagulants. The soluble macromolecules are often humic, fulvic or other natural organic matter (NOM) which are difficult to bio-degrade. They can partly be removed by chelating with iron based inorganic coagulants. Organic coagulants such as polydiallyldimethylammonium chloride (pDADMAC) or polyamines such as copolymers of epichlorohydrin and dimethylamine are also effective in removing these materials. The small organic molecules, which cannot be removed from the wastewater by coagulation, can be readily absorbed by activated carbon.

Powdered active carbon (PAC) is widely used in potable or waste water treatment for removal of organic chemical. PAC particles usually have an average diameter (d50) of 0.01 mm (>200 mesh). It is a very fine dust which is not easy to handle and also poses a dust explosion hazard, PAC must be handled by special equipment during transport, storage and dosing. PAC dosages are typically high in continuous processes and a slurry feeding system is usually required at wastewater treatment sites. PAC is hydrophobic and difficult to wet, specially designed equipment is needed to disperse PAC in water resulting in the formation of a slurry. In addition to dust, wetting, and dust explosion issues, PAC slurries are prone to sedimentation problems as PAC tends to settle at the bottom of pipelines, storage tanks and reaction tanks.

US 2007/0187334 A1 discloses the use of a cationic aqueous coagulants solution containing polydiallyldimethlammonium chloride (pDADMAC), polyquaternary amine (polyamine), or starch based organic polymers blended with either each other or inorganic metal salts including ferric chloride, ferrous sulfate, aluminium sulfate, aluminium chlorohydrate and poly aluminium chloride. Further, powdered activated carbon is also mixed in the coagulant solution to further treat in situ the wastewater for COD.

It is an object of at least one aspect of the present invention to obviate or mitigate at least one or more of the aforementioned problems.

### SUMMARY OF THE INVENTION

According to a first aspect of the present invention, there is provided a COD removal mixture comprising:
a) at least one inorganic coagulant;
b) activated carbon;
c) optionally at least one organic coagulant; and
d) optionally water;
wherein the mixture is a powder.

We have found that powdered activated carbon can be easily dispersed in certain inorganic and organic coagulants, thus relieving the sedimentation issues and the problems of handling and dosing multiple chemicals. Further, by pre-mixing the components together, overall product particle size increases. Problems with dust and wetting are avoided.

By powder in the present invention is meant any solid substance which consists of discrete particles.

The inorganic coagulant may be an inorganic salt having aluminium and/or iron as cations, and chloride and/or sulfate as anions.

The inorganic coagulant may be selected from the group consisting of iron sulfate, polyferric sulfate, iron chloride, potassium alum, aluminium sulfate, aluminium chloride, aluminium chlorohydrate, polyaluminium chloride and any combination thereof.

The inorganic coagulant may be selected from the group consisting of polyferric sulfate, aluminium chlorohydrate, polyaluminum chloride and any combination thereof.

The organic coagulant may be poly diallyldimethylammonium chloride.

The activated carbon may have an average particle size of below 0.074 mm (<200 mesh).

The COD removal mixture powder may have a bulk density of about 0.3 g/m³ to about 0.6 g/m³ or alternatively about 0.4 g/m³ to about 0.5 g/m³.

The COD removal mixture may comprise about 5 wt. % to about 85 wt. % of the at least one inorganic coagulant.

The COD removal mixture may comprise about 10 wt. % to about 70 wt. % of activated carbon.

The COD removal mixture may comprise about 0 wt. % to about 20 wt. % of the at least one organic coagulant.

The COD removal mixture may comprise about 5 wt. % to about 45 wt. % of water.

According to a second aspect of the invention there is provided a method of clarifying industrial wastewater including the steps of:
providing a COD removal mixture;
dispersing the COD removal mixture in water to provide a COD removal suspension;
adding the COD removal suspension to industrial wastewater to provide a reaction mixture; and
optionally further adding a flocculant to said reaction mixture.

The COD removal suspension may comprise about 0.2 wt. % to about 20 wt. % of the COD removal mixture with regard to components a) to d) of the COD removal mixture.

The flocculant may be a polyacrylamide and the polyacrylamide may be an anionic polyacrylamide.

By clarifying is meant purifying and the removal of undesired components and species.

The COD removal suspension may comprise about 0.2 wt. % to about 20 wt. % of the COD removal mixture with regard to components a) to d) of the COD removal mixture. Alternatively, the COD removal suspension may comprise about 1 wt. % to about 10 wt. % of the COD removal mixture with regard to components a) to d) of the COD removal mixture.

In a further embodiment the COD removal mixture comprises:
a) at least one inorganic coagulant selected from the group consisting of iron(III) sulfate, polyferric sulfate, iron(III) chloride, potassium alum, aluminium chloride, aluminium sulfate, aluminium chlorohydrate, polyaluminum chloride, and any combination thereof;
b) powdered activated carbon;
c) optionally at least one organic coagulant, wherein the organic coagulant is poly diallyldimethylammonium chloride; and
d) water;
wherein the mixture is a powder.

In a further embodiment the COD removal mixture comprises:
a) from about 5 wt. % to about 85 wt. % of at least one inorganic coagulant selected from the group consisting of iron(III) sulfate, polyferric sulfate, iron(III) chloride, potassium alum, aluminium chloride, aluminium sulfate, aluminium chlorohydrate, polyaluminum chloride and any combination thereof;
b) from about 10 wt. % to about 70 wt. % of activated carbon;
c) from about 0 wt. % to about 20 wt. % of at least one organic coagulant, wherein the organic coagulant is poly diallyldimethylammonium chloride; and
d) from about 0 wt. % to about 45% wt. % of water;
wherein the mixture is a powder.

In a further embodiment the COD removal mixture comprises:
a) from about 10 wt. % to about 70 wt. % of at least one inorganic coagulant selected from the group consisting of polyferric sulfate, iron(III) chloride, aluminium chlorohydrate, polyaluminum chloride, and any combination thereof;
b) from about 20 wt. % to about 60 wt. % of activated carbon;
c) from about 0 wt. % to about 10 wt. % of at least one organic coagulant, wherein the organic coagulant is poly diallyldimethylammonium chloride;
d) from about 10 wt. % to about 45% wt. % of water; and
wherein the mixture is a powder.

In a further embodiment the COD removal mixture comprises:
a) from about 15 wt. % to about 60 wt. % of at least one inorganic coagulant selected from the group consisting of polyferric sulfate;
b) from about 25 wt. % to about 55 wt. % of activated carbon having an average particle size of below about 0.01 mm;
c) from about 0 wt. % to about 5 wt. % of at least one organic coagulant, wherein the organic coagulant is poly diallyldimethylammonium chloride;
d) from about 20 wt. % to about 40 wt. % of water; and

wherein the mixture is a powder.

Optionally the wt. percentages for components a) to d) of the COD removal mixture may add up to 100 wt. %.

### DETAILED DESCRIPTION OF THE INVENTION

The present invention relates to the chemical oxygen demand (COD) removal mixtures which are powders and the use of these COD removal mixtures for preparing COD removal solutions for use in clarifying industrial wastewater, specifically those wastewaters obtained after biological treatment.

### Inorganic Coagulants

The COD removal mixture of the present invention comprises as component a) at least one inorganic coagulant. Inorganic coagulants are used in order to remove suspended solids as well as soluble macromolecules from wastewater by absorption or forming chelate complexes between the soluble macromolecules and the iron or aluminium ions.

The inorganic coagulant of component a) of the COD removal mixture may be an inorganic salt having iron and/or aluminium as cations. The inorganic coagulant may be an inorganic salt having chloride and/or sulfate as anions. The inorganic coagulant may be an inorganic salt having iron and/or aluminium as cations, and chloride and/or sulfate as anions.

The inorganic coagulant of component a) of the COD removal mixture may be selected from the group consisting of iron sulfate, polyferric sulfate, iron chloride, potassium alum, aluminium sulfate, aluminium chloride, aluminium chlorohydrate, polyaluminium chloride or any combination thereof.

The inorganic coagulant of component a) of the COD removal mixture may be selected from the group consisting of iron(III) sulfate (Fe₂(SO₄)₃), polyferric sulfate ([Fe₂(OH)ₙ(SO₄)_{(3-n)/2}]ₘ, iron(III) chloride (FeCl₃), potassium alum (KAl(SO₄)₂), aluminium sulfate (Al₂(SO₄)₃), aluminium chloride (AlCl₃), aluminium chlorohydrate, polyaluminum chloride (AlₓCl_{(3x-y)}OH)_{y}); and any combination thereof.

Polyferric sulfate may be described by the formula [Fe₂(OH)ₙ(SO₄)_{(3-n)/2}]ₘ with n<2 and m>10. The inorganic coagulants typically have particle sizes of between about 0.2 to about 0.8 mm.

In a preferred embodiment, the inorganic coagulant of component a) of the COD removal mixture is polyferric sulfate. The COD removal mixture may comprise about 5 wt. % to about 85 wt. % of the inorganic coagulant, alternatively about 10 wt. % to about 70 wt. % or alternatively about 15 wt. % to about 60 wt. % based on the total COD removal mixture.

### Organic Coagulants

The COD removal mixture of the present invention may further comprise as component c) at least one organic coagulant. Organic coagulants are used for removing humic, fulvic and other organic matter possibly through cationic-anionic charge interactions. Overall dosage and sludge volume can be significantly reduced by using organic coagulants.

The organic coagulant of component c) of the COD removal mixture may be selected from the group consisting of poly diallyldimethylammonium chloride (pDADMAC), a copolymer of epichlorohydrin and dimethylamine, formaldehyde cyano-guanidine copolymer and any combination thereof.

The organic coagulant of component c) of the COD removal mixture may be provided in solution or as micro beads in a size of about 1 mm.

The COD removal mixture may comprise about 0 wt. % to about 20 wt. % of the organic coagulant, alternatively about 0 wt. % to about 10 wt. % or about 0 wt. % to about 5 wt. % of the organic coagulant based on the total COD removal mixture.

The COD removal mixture may comprise 5 wt. % to 10 wt. % of at least one coagulant.

Organic coagulants also serve the purpose of dispersing activated carbon in solution and preventing its fast sedimentation.

### Activated Carbon (PAC)

The COD removal mixture of the present invention further comprises as component b) activated carbon. In potable water treatment, it is generally suggested to add PAC at the head of water stream before applying coagulants. We found that pre-mixing PAC with inorganic and organic coagulants and dosing all components together does not have a detrimental effect on PAC's absorption capability in industrial wastewater treatment. This is probably due to the higher concentration of suspended solids and macromolecules in industrial wastewater compared to potable water and municipal wastewater. These contaminants may coat the PAC particles upon contact and reduce PAC absorption speed and capacity. By aggregating these contaminants first with coagulants, PAC particles can be left free to absorb small organic molecules and thus overall COD removal efficiency is increased. This effect may cancel the detrimental effect of coagulants coating PAC particles and reducing their absorption capability.

Activated carbon typically can pass through screens of about 80 mesh, i.e. particle sizes smaller than about 0.177 mm. Alternatively, the activated carbon used in the present invention may pass through screens of about 140 mesh, i.e. having particle sizes below about 0.105 mm, or alternatively pass through screens of below about 200 mesh, i.e. having particle sizes below about 0.074 mm. It is preferable to employ activated carbon particles having particle sizes below about 0.074 mm which require less time for absorption.

The COD removal mixture may comprise about 10 wt. % to about 70 wt. % of the activated carbon, alternatively about 20 wt. % to about 60 wt. % or about 25 wt. % to about 55 wt. % of activated carbon based on the total COD removal mixture.

### Water

To further alleviate dust and other issues, water may be added to the COD removal mixture. Water may be added with the components of the COD removal mixture; inorganic and organic coagulants are commercially available in liquid form, i.e. the active component solubilized or dispersed in water. Alternatively, water may be added separately to wet the overall COD removal mixture, preferably by spraying water onto the COD removal mixture during blending.

The water comprised in the COD removal mixture agglomerates the PAC and coagulant particles. The water content in the final COD removal mixture will not render the mixture sticky or result in the formation of a slurry but the powder will be free flowing. At the same time addition of water further reduces the dust issues of the COD removal mixture.

The COD removal mixture may contain about 0 wt. % to about 45 wt. % of water, alternatively about 10 wt. % to about 45 wt. % of water or about 20 wt. % to about 40 wt. % of water based on the total COD removal mixture.

Alternatively, the COD removal mixture may contain about 5 wt. % to about 40 wt. % of water, about 10 wt % to about 30 wt. % water or about 15 wt. % to about 25 wt. % water based on the total COD removal mixture.

The COD removal mixture may consist only of the different components a) to d). Optionally the wt. percentages for components a) to d) of the COD removal mixture may add up to 100 wt. %.

### Powder

The COD removal mixture of the present invention is characterized in that the mixture is a powder. The powder may consist of discrete particles. The powder may a free-flowing powder. The powder may be an interactive mixture of the different components a) to d) with the activated carbon particles (PAC) adhering together by the bigger particles of the inorganic and/or organic coagulants. The COD removal mixture may be a powder having a bulk density of about 0.3 to about 0.6 g/m³, and/or an average particle size D50 between about 0.02 to about 0.5 mm.

The COD removal mixture of the present invention may be prepared by mixing the components of a), b) and c) using mechanical means, for example ribbon and plough blenders, agitators or homogenisers. Water may be added before or during blending by spraying onto mixture. If any of components a) or c) is used as a liquid or when any of components a) or c) is used as a solution, this component may be sprayed onto the COD removal mixture before or during blending.

### Particle Sizes

Particle sizes can be determined optically (for example direct imaging and laser diffraction) or through sieve analysis. D-values (D10, D50 and D90) given are the intercepts for 10%, 50% and 90% of the cumulative mass. D10 is the diameter at which 10% of the sample's mass is comprised of particles with a diameter less than this value. D50 is the diameter of the particle that 50% of the sample's mass is smaller than and 50% of the sample's mass is larger than.

### Clarifying Industrial Wastewater

A further aspect of the present invention is a method of clarifying industrial wastewater including the steps of:
providing a COD removal mixture according to the present invention;
dispersing the COD removal mixture in water to provide a COD removal suspension;
adding the COD removal suspension to industrial wastewater to provide a reaction mixture; and
optionally further adding a flocculant to said reaction mixture.

The term “clarifying” is generally used to refer to a method of removing solid particulates or suspended solids from wastewater.

The COD removal mixtures of the present invention can easily be dispersed in water. In one embodiment, the COD removal suspension may comprise about 0.2 wt. % to about 20 wt. % of the COD removal mixture, alternatively about 1 wt. % to about 10 wt. % and in a further embodiment about 2 wt. % to about 5 wt. % with regard to components a) to c) of the COD removal mixture.

After addition of the COD removal suspension to the industrial wastewater and optionally after addition of flocculant to the reaction mixture, the reaction mixture may be stirred for a time ranging from about 5 mins to about 60 mins. The stirring may be followed by the sedimentation process which may last for about 1 hour to about 5 hours. All steps may be carried out at a temperature in the range of about 5° C. to about 50° C.

The term “industrial wastewater” is used with respect to any wastewater originating from industrial processes which may include coking industry, chemical industry, pulp and paper industries, refineries and industrial parks. The industrial wastewater may have a pH of about 6 to about 8. The industrial wastewater may have been biologically treated.

Optionally, flocculants may be added to the reaction mixture comprising the industrial wastewater and the COD removal suspension. The flocculant may be selected from polyacrylamide. The polyacrylamide may be cationic or anionic. An anionic polyacrylamide may be used as flocculant. The reaction mixture may comprise about 0.5 to about 3 ppm of the flocculant. Addition of the flocculant may accelerate the sedimentation process.

### EXAMPLES

The following examples are provided to illustrate the invention but are not intended to limit the scope of the claims.

### Example 1: COD Removal Mixture

The following powdered COD removal mixture has been prepared by mixing the different component powders/beads using a ribbon blender and spraying the water onto the powder during blending (Table 1).

TABLE 1
COD removal mixture

| | Weight percentage |
|---|---|
| Component | (%) |
| Polyferric sulfate (solid powder, 19% total | 48 |
| iron, D50 = 170 μm) | |
| Poly diallyldimethlyammonium chloride | 5 |
| (solid beads, D50 = 890 μm, 85% actives) | |
| Activated carbon (>200 mesh, D50 = 7 μm) | 30 |
| Water | 20 |

The resulting COD removal mixture is a free flowing powder (D10=9.4 μm, D50=49 μm, D90=580 μm).

### Example 2: COD Removal Mixture

The following COD removal mixture has been prepared by mixing the different component powders/beads using a ribbon blender with water being sprayed onto the powder during blending (Table 2).

TABLE 2
COD removal mixture

| | Weight percentage |
|---|---|
| Component | (%) |
| Aluminium chlorohydrate (solid powder, 30 wt. % | 63 |
| Al₂O₃ actives, D50 = 210 μm) | |
| Poly diallyldimethylammonium chloride (Solid | 3 |
| beads, 85 wt. % actives, D50 = 890 μm,) | |
| Activated carbon (particle size >200 mesh, | 22 |
| D50 = 7 μm) | |
| Water | 12 |

The resulting COD removal mixture is a free flowing powder (D10=11 μm, D50=110 μm, D90=700 μm).

### Example 3: COD Removal Mixture

The following powdered COD removal mixture has been prepared by mixing the activated carbon using a plough blender with the solution of Poly diallyldimethylammonium chloride and the liquid polyferric sulfate being sprayed onto the powder surface during blending (Table 3).

TABLE 3
COD removal mixture

| | Weight percentage |
|---|---|
| Component | (%) |
| Polyferric sulfate (liquid, 11 wt. % total iron) | 40 |
| Poly diallyldimethlyammonium chloride (in solu- | 10 |
| tion, 20 wt. % actives) | |
| Activated carbon (particle size >200 mesh, | 50 |
| D50 = 7 μm) | |

The resulting COD removal mixture is a free flowing powder (D10=33 μm, D50=320 μm, D90=1.1 mm).

### Example 4: COD Removal Mixture

The following powdered COD removal mixture has been prepared by mixing the different component powders using a plough blender with the liquid components being sprayed onto the powders during blending (Table 4).

TABLE 4
COD removal mixture

| | Weight percentage |
|---|---|
| Component | (%) |
| Aluminium chlorohydrate (solid powder, 30 wt. % | 15 |
| Al₂O₃ actives, D50 = 130 μm) | |
| Epichlorohydrin dimethylamine copolymer (liquid | 7 |
| 50 wt. % actives) | |
| Activated carbon (>200 mesh, D50 = 7 μm) | 50 |
| Water | 28 |

The resulting COD removal mixture is a free flowing powder (D10=33 μm, D50=290 μm, D90=1 mm).

### Example 5: Jar Test Procedure

A solution of 10 wt. % of the respective COD removal mixture in water was added to the industrial wastewater followed by rapid mixing for 10 to 20 minutes in a flash mix chamber to completely dissolve the COD removal mixture in the water. Further, a 0.2% solution of an anionic polyacrylamide was added to the dissolved COD removal mixture under rapid mixing for 0.5 minutes. In order to mimic the flocculation basin, mixing was continued more slowly for 5 to 10 minutes to allow for the floc particles to cluster. After the mixing was stopped completely, the reaction mixture was allowed to settle as it would in the sedimentation basin. The supernatant was used to determine the COD content as shown in Example 6.

### Example 6: Hach's COD Measurement Procedure

2 ml of the supernatant obtained according to Example 5 was added to Hach's COD digestion vials (low range 3-150 mg/L) and heated to 150° C. for 2 hours. After cooling down, the COD content was determined using the Hach DR 3900 spectrophotometer.

### Example 7: COD Removal Efficiency

Wastewater samples (after biological treatment) were collected from various industry origins. The results shown in Table 5 have been produced using the Jar Test procedure of Example 5 and the Hach's COD measurement procedure of Example 6. To accelerate sedimentation, anionic flocculant Optimer®9901 of Nalco has been used at a dosage of 2 ppm.

TABLE 5

| | | Bio-effluent Wastewater | | | | | | |
|---|---|---|---|---|---|---|---|---|
| | | | Filtered | | | | Treated wastewater | |
| | | Total | COD (0.45 | | COD removal | | Supernatant | |
| Sample | Industry Origin | COD | μm filter) | Turbidity | mixture From | Dosage | COD | Turbidity |
| No. | of wastewater | (mg/L) | (mg/L) | (NTU) | example No. | (ppm) | (mg/L) | (NTU) |
| 1 | Coke | 302 | 264 | 15 | 1 | 500 | 127 | 1 |
| 2 | Coal chemical | 278 | 188 | 118 | 1 | 500 | 81 | 2 |
| 3 | Printing and dyeing | 85 | 83 | 4 | 1 | 300 | 66 | 1 |
| 4 | Paper | 138 | 98 | 270 | 1 | 500 | 44 | 3 |
| 5 | Municipal | 49 | 26 | 18 | 2 | 300 | 20 | 4 |
| 6 | Chemical (leather) | 242 | 202 | 10 | 3 | 300 | 132 | 1 |
| 7 | Chemical (Polymer) | 167 | 109 | 9 | 4 | 1000 | 44 | 1 |

All examples show a considerable removal of COD after use of the COD removal mixtures of the present invention.

### Example 8: Sedimentation and Wetting

A 10% aqueous slurry of COD removal mixture shown in Example 3 was allowed to settle in a cylinder with a 5% aqueous PAC slurry as control. Setting speed is defined as the sludge layer level decrease over time. The PAC layer settling speed is rapid for control (fully settled in 10 minutes), and slow for the COD removal mixture slurry (<10% sedimentation for 1 hour).

### Example 9: Dispersal

10 g of COD removal mixture shown in table 3 was added to 100 ml water in a beaker with magnetic stirring. The COD removal mixture is dispersed in water immediately without dust. For comparison, 5 g powder of activated carbon was added to 100 ml water in a beaker with magnetic stirring. The activated carbon floated on top of the water, creating a dust cloud during the magnetic stirring.

1. A COD removal mixture comprising:
a) at least one inorganic coagulant;
b) activated carbon,
c) at least one organic coagulant; and
d) optionally water,
wherein the mixture is a powder.

2. The COD removal mixture of claim 1, wherein the inorganic coagulant is an inorganic salt having aluminum and/or iron as cations, and chloride and/or sulfate as anions.

3. The COD removal mixture of claim 1, wherein the inorganic coagulant is selected from the group consisting of iron sulfate, polyferric sulfate, iron chloride, potassium alum, aluminum sulfate, aluminum chloride, aluminum chlorohydrate, polyaluminum chloride and any combination thereof.

4. The COD removal mixture of claim 1, wherein the inorganic coagulant is selected from the group consisting of polyferric sulfate, aluminum chlorohydrate, polyaluminum chloride and any combination thereof.

5. The COD removal mixture of claim 1, wherein the organic coagulant is poly diallyldimethylammonium chloride.

6. The COD removal mixture of claim 1, wherein the activated carbon has an average particle size of below 0.074 mm (<200 mesh).

7. The COD removal mixture of claim 1, wherein the powder has a bulk density of about 0.3 g/m³ to about 0.6 g/m³.

8. The COD removal mixture of claim 1, wherein the COD removal mixture comprises about 5 wt. % to about 85 wt. % of the inorganic coagulant.

9. The COD removal mixture of claim 1, wherein the COD removal mixture comprises about 10 wt. % to about 70 wt. % of activated carbon.

10. The COD removal mixture of claim 1, wherein the COD removal mixture comprises about 0 wt. % to about 20 wt. % of the organic coagulant.

11. The COD removal mixture of claim 1, wherein the COD removal mixture comprises about 5 wt. % to about 45 wt. % of water.

12. Method of clarifying industrial wastewater including the steps of:
providing a COD removal mixture according to claim 1;
dispersing the COD removal mixture in water to provide a COD removal suspension;
adding the COD removal suspension to industrial wastewater to provide a reaction mixture; and
optionally further adding a flocculant to said reaction mixture.

13. The method of claim 12, wherein the COD removal suspension comprises about 0.2 wt. % to about 20 wt. % of the COD removal mixture with regard to components a) to d) of the COD removal mixture.

14. The method of claim 12, wherein the flocculant is a polyacrylamide.

15. The method of claim 14, where in the polyacrylamide is an anionic polyacrylamide.
